(19) United States
(12) Patent Application Publication
(10) Pub. No.: US 2015/0128081 A1
(43) Pub. Date: May 7, 2015

(54) Customized Smart Phone Buttons

(71) Applicant: Acer Incorporated, New Taipei City (TW)

(72) Inventor: Meng-Fu HSIEH, New Taipei City (TW)

(73) Assignee: Acer Incorporated, New Taipei City (TW)

(21) Appl. No.: 14/277,972

(22) Filed: May 15, 2014

(30) Foreign Application Priority Data
Nov. 6, 2013 (TW) 102140347

(51) Int. Cl. G06F 3/0488; G06F 3/0485

(52) U.S. Cl. CPC G06F 3/04886; G06F 3/0485
USPC 715/773

(57) ABSTRACT

Presented herein are techniques to enable a user of an electronic device having a display and touch screen to customize the size and location of a displayed keypad or keyboard such that the user can more easily hold the electronic device and operate the keypad or keyboard using a single hand. The techniques include detecting a touch operation input via the touch screen, the touch operation including a start point, an end point and a drag path between the start point and the end point; and when the start point is located at a first boundary of the touch screen and the end point is located at a second boundary of the touch screen, defining a bounded area of the display according to the first boundary, the second boundary and the drag path in which the set of keys is to be re-displayed.

### RELATED APPLICATION DATA

This application claims priority under 35 U.S.C. §119 to Taiwan patent application TW 102140347, filed on Nov. 6, 2013, the disclosure of which is incorporated herein by reference in its entirety.

### TECHNICAL FIELD

### Background

Today's information society continues to increasingly rely on consumer electronic devices including, but not limited to, smart phones, e-books, and tablet computers, among other devices. These devices enable people to gain access to, for example, the Internet while mobile, or stationary. One of the particularly notable features of such consumer devices, and one that has increased the popularity of such devices, is the touch screen. A touch screen, in combination with an associated display, enables a user to perform various operations with the electronic device including viewing graphical and text information, as well as simultaneously inputting text via a displayed keyboard or providing touch input responsive to a given display.

In many electronic devices, the display area of a displayed keyboard is fixed. For example, in many common electronic devices available in the market today, the keyboard size rendered on a display of the electronic device might consume a fixed space that might be on the order of half of the entire available display space. In many cases, because of the physical size or form factor of the electronic device (and its display/touch screen), a user might have difficulty operating the keyboard with a single hand while simultaneously holding the electronic device in the same hand. That is, many users hold electronic devices in the palm of a hand and use that hand's thumb to tap respective keys of the displayed keyboard. This type of operation is particularly popular when the keyboard is a dial pad or keypad to enter, e.g., a telephone number to make a telephone call or to send a text message. However, depending on the size of the user's hand, that user might not be able to reach each key of the keypad with their thumb while holding the electronic device in a single hand. This can lead to errors in key selection or simply the inability to operate the electronic device in a satisfactory way using only a single hand.

### SUMMARY

In accordance with certain embodiments presented herein, a method is provided. The method comprises displaying a set of keys on an electronic device having a touch screen and a display, detecting a touch operation input via the touch screen, the touch operation including a start point, an end point and a drag path between the start point and the end point, and when the start point is located at a first boundary of the touch screen and the end point is located at a second boundary of the touch screen, defining a bounded area of the display according to the first boundary of the touch screen, the second boundary of the touch screen and the drag path in which the set of keys is to be re-displayed.

In accordance with other embodiments, an apparatus, in the form of an electronic device, is provided. The apparatus comprises a touch screen including an associated display, a memory, and a processor in communication with the touch screen and memory, wherein the memory includes a detection module configured to detect a touch operation input via the touch screen, the touch operation including a start point, an end point and a drag path between the start point and the end point, a keyboard change module configured to define a bounded area of the display according to the first boundary of the touch screen, the second boundary of the touch screen and the drag path, and a keyboard display module configured to cause a re-sized version of a set of keys to be displayed substantially in the bounded area of the display.

### BRIEF DESCRIPTION OF THE DRAWINGS

Embodiments are described herein in conjunction with the accompanying drawings, in which:

FIG. 1 is a block diagram of an electronic device in accordance with an embodiment of the present invention;

FIG. 2 illustrates an example keypad (keyboard) that may be rendered or displayed on the electronic device;

FIG. 3 is a flow chart illustrating example processing steps performed by the electronic device in accordance with an embodiment of the present invention;

FIGS. 4A and 4B depict how a keypad (keyboard) may be rendered or displayed on the electronic device in accordance with an embodiment of the present invention;

FIG. 5 is a flow chart illustrating example processing steps performed by the electronic device in accordance with another embodiment of the present invention;

FIGS. 6A-6C depict how a keypad (keyboard) may be rendered or displayed on the electronic device in accordance with the another embodiment of the present invention;

FIG. 7 is a flow chart illustrating example processing steps performed by the electronic device in accordance with yet another embodiment of the present invention;

FIGS. 8A-8C depict how a keypad (keyboard) may be rendered or displayed on the electronic device in accordance with the yet another embodiment of the present invention.

### DESCRIPTION OF EXAMPLE EMBODIMENTS

Generally, when using a software-generated keypad (referred to herein, simply, as a “keypad” or, alternatively, as a “keyboard”) on an electronic device provided with a touch screen, the keypad might occupy half or even more of the display area of the display. If the touch screen of the electronic device is large, the use of both hands is often required to select keys on the keypad. That is, it is not uncommon that a user's hand is simply too small to reach all of the keys of the keypad while holding onto the electronic device with a single hand. To address this issue, and to provide a more favorable operating experience, embodiments of the present invention provide mechanisms and processes by which a user may customize the size of the keypad that is displayed on the electronic device such that the user may more easily operate the keypad with only a single hand while holding the electronic device in the same hand.

FIG. 1 depicts a block diagram of an electronic device in accordance with an embodiment of the present invention. In this embodiment, an electronic device 10 such as a cell phone, smart phone, personal digital assistant (PDA), tablet PC, e-book, or game console, among other possibilities, includes a touch screen 12, a storage unit or memory 14 and one or more processing units or, collectively, processor 16, the functions of which are described below.

Touch screen 12 is, e.g., an integrated touch screen touch display device that provides display and touch input functionality simultaneously. The display device, typically arranged under the touch screen, may be a liquid crystal display (LCD), light emitting diode (LED) displays, field emission displays (FED) or any other suitable type of display that can operate in conjunction with a touch sensitive screen. Those skilled in the art will appreciate that the present invention is not intended to be limited to any particular type of display technology.

Touch screen 12 is configured to comprise touch detection elements or devices (not shown) disposed therein/thereon, which enable touch screen 12 to sense received touch events. Touch events may be provided by a user's fingers, hands, other body parts or other objects that are caused to come into contact with (i.e., touch) touch screen 12. The touch detection elements may be, for example, capacitive touch detection devices, surface acoustic wave touch detection devices, electromagnetic touch detection devices, near-field imaging touch detection devices, or any other suitable devices capable of sensing/detecting touch input and providing sense signals to, e.g., processor 16 or other component.

Storage unit or memory 14, may be, for example, any type of fixed or removable random access memory (RAM), read-only memory (ROM), flash memory, hard drive or a combination of such devices, or any other suitable form of memory that is capable of storing logic instructions (e.g., software, firmware, etc.) that can be executed by processor 16 to perform the functionality described herein.

Processor 16, may be, for example, a central processing unit (CPU), or other programmable general purpose or special-purpose microprocessor, digital signal processor (DSP), programmable controller, application specific integrated circuits (ASIC), programmable logic devices (PLD) or other suitable processor capable of performing functionality described herein. As shown in FIG. 1, processor 16 is coupled to touch screen 12 and memory 14, such that, e.g., logic instructions stored in memory 14 can be accessed by processor 16. As further depicted in FIG. 1, memory 14 may be considered, for purposes of the instant disclosure, to have three separate (e.g., software) modules: a detection module 142, a keyboard change module 144, and a keyboard display module 146. As noted, these modules may be software, logic instructions, computer programs, firmware, etc. that can be loaded into, or operated in conjunction with, processor 16 to implement the functionality described hereinbelow. Although modules 142, 144, 146 are described separately, those skilled in the art will appreciate that their functionality could be combined into fewer or divided into more modules.

Briefly, detection module 142 is configured to detect whether a user intends to make a change to a sizing and/or location of the keypad, keyboard change module 144 is configured, responsive to detection module 142, to cause a change to how the keypad is displayed, and keyboard display module 146 is configured to cause a re-sized and/or re-located keypad to be displayed on the display associated with touch screen 12.

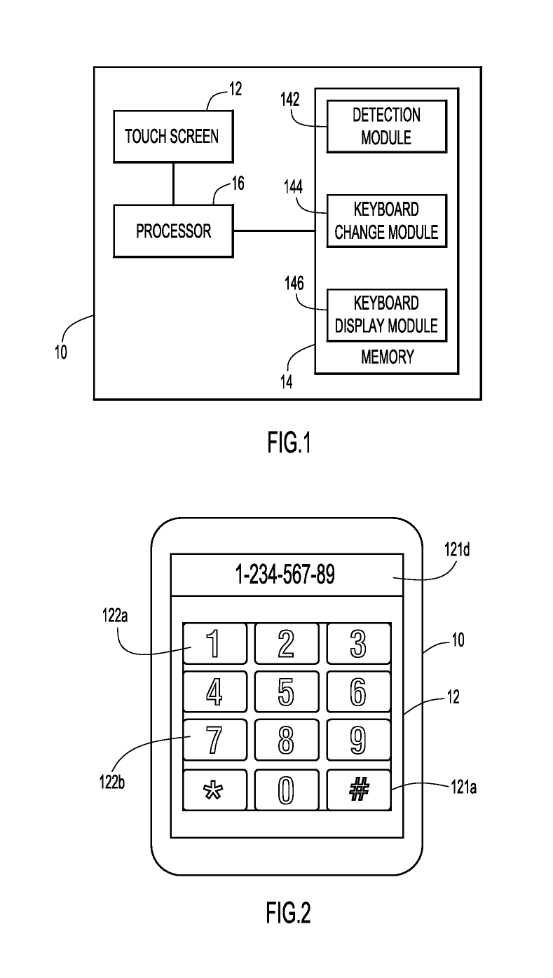

FIG. 2 illustrates an example keypad (keyboard) that may be rendered or displayed on the electronic device. In the depicted example, keypad 121a is configured to enable a user to dial a telephone number and perform other telephone keypad operations. As shown, keypad 121a occupies most of the available area of touch screen 12, and includes a plurality of keys 122a, 122b. As the user touches individual keys on keypad 121a, numbers corresponding to the keys are displayed in number display field 121d.

In accordance with an embodiment of the present invention, when a user operates the electronic device 10 to display keypad 121a, keypad 121a is rendered in a default size, which in FIG. 2, utilizes almost all of the area of touch screen 12.

However, in the case where a user has trouble using a single hand to simultaneously hold electronic device 10 and operate keypad 121a, the user, in accordance with described embodiments can change the size and location of keypad 121a to more easily operate keypad 121a with a single hand.

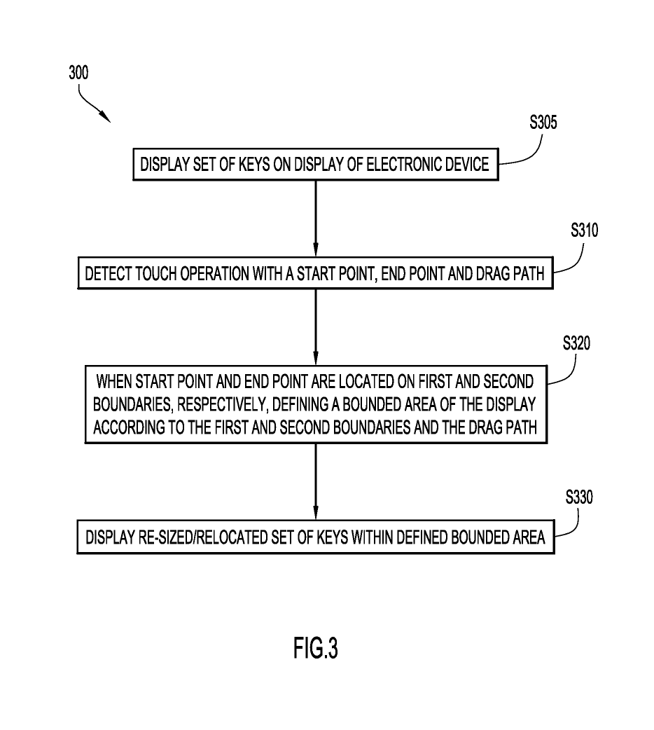

Reference is now made to FIG. 3, which depicts a flow chart illustrating example processing steps 300 performed by electronic device 10 in accordance with an embodiment of the present invention. Those skilled in the art will appreciate that although the instant embodiment is being described with respect to a dial keypad, other keyboards can also benefit from the functionality described herein, including QWERTY style keyboards.

Referring to FIG. 3, at step S305 a set of keys is displayed on a display of an electronic device. At step S310 detection module 142 detects a particular type of touch operation applied to touch screen 12. Specifically, detection module 142 detects a start point and an end point of a first touch operation, as well as a moving or dragging path associated with the start and end points.

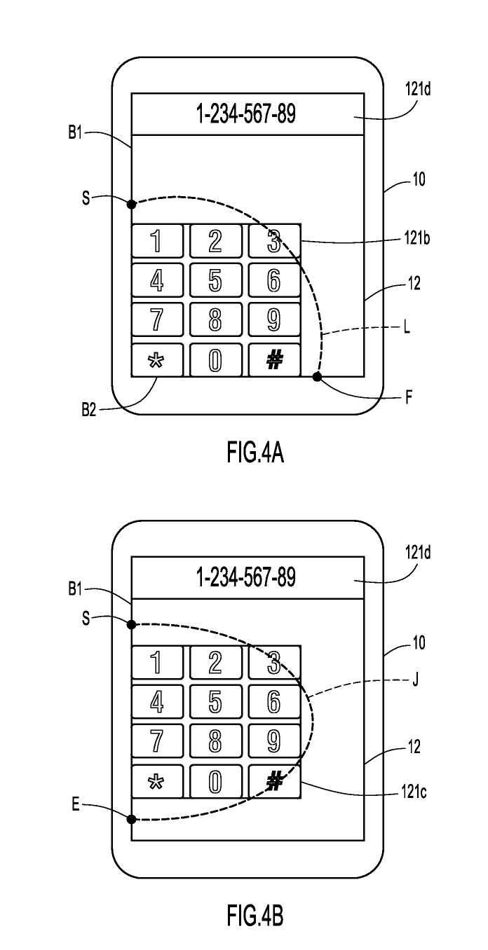

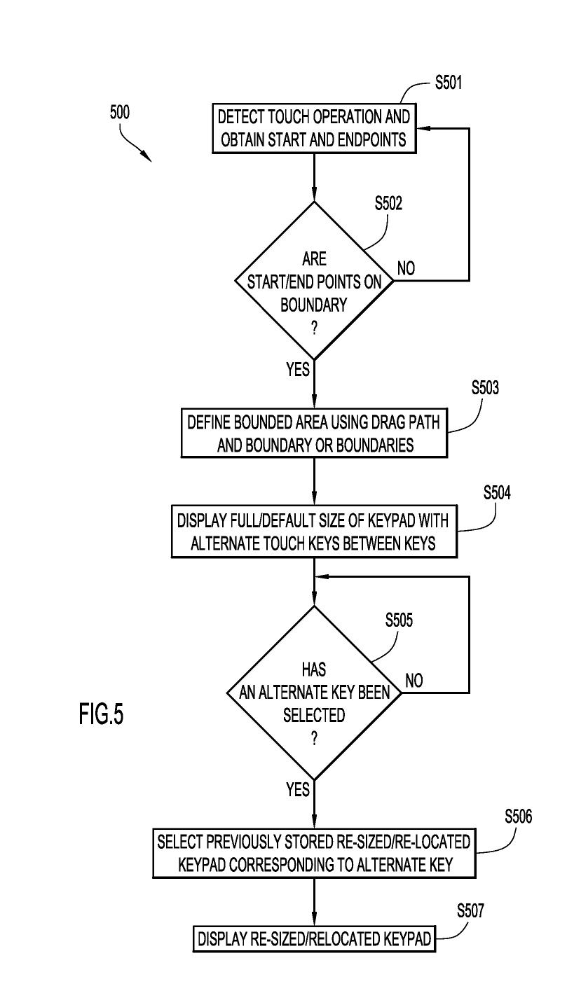

With the start and end points now known, the process continues with step S320, where it is determined whether the start point of the touch operation is located on a boundary or edge of the touch screen 12 and whether the end point of the touch operation is located on a second boundary or edge of the touch screen 12. If so, a bounded area is then defined by the boundaries and a drag path between the start point and the end point. Reference can be made to FIG. 4A for a more clear understanding of this step. As shown in FIG. 4A, a start point S of a touch operation is shown on a first boundary B1 of touch screen 12 and an end (finish) point F of the same touch operation is shown on a second boundary B2 of touch screen 12. Drag path L (e.g., made by a user's thumb when holding electronic device 10 in one hand) is also depicted as extending between start point S and end point F. Thus, as can be seen, an area bounded by the first boundary B1 and the second boundary B2 as well as the drag path L can be defined.

The bounded area defined by the two boundaries B1, B2 and the drag path L is then provided to keyboard change module 144 so set a size and location of the keypad on the display. That is, keyboard change module 144 is configured to determine a size of a keypad that fits substantially within the bounded area defined by boundaries B1, B2 and the drag path L.

Information regarding the determined keypad size/location is then passed to keyboard display module 146 such that keypad 121b (the re-sized/re-located keypad) can be rendered or displayed within that bounded area, as indicated by step S330. That is, as shown in FIG. 4A, keypad 121b is a reduced size version of keypad 121a (in FIG. 1) and is also located in the bottom left-hand corner of touch screen 12, corresponding to the defined bounded area. In so defining the bounded area using the user's own touch input while operating electronic device 10, the methodology described herein can ensure that the newly-rendered keypad is customized to the user's reach of his fingers while holding electronic device 10 in one hand.

It is noted that the first and second boundaries need not be different boundaries (e.g., orthogonal boundaries), but rather could be the same boundary of touch screen 12. As shown in FIG. 4B, the start point S of the touch input is located on boundary B1 (the left-hand vertical side of touch screen 12) and the end point E is likewise located on boundary B1 (the same left-hand vertical side of touch screen 12). The drag path J in this case may be, e.g., a parabolic shape with end points S, E disposed on a same boundary (B1) of touch screen 12. Because the process described herein renders a re-sized keypad within the bounded area of the touch screen boundaries and the drag path, in the case of FIG. 4B keypad 121c is rendered not in the lower left-hand corner of touch screen 12 (as depicted in FIG. 4A), but is instead rendered substantially midway along the vertical left-hand boundary of touch screen 12. Those skilled in the art will art will appreciate that the examples of FIGS. 4A and 4B are consistent with a user using his/her left hand and thumb, and that for a user using his/her right hand and thumb, the keypad might be re-sized and rendered toward the right side of touch screen 12. Similarly, the keypad could be rendered along the lower or upper boundaries of touch screen 12, as well.

Furthermore, although the examples depicted in FIGS. 4A and 4B show that the keypad maintains the same key configuration or arrangement, i.e., three rows by four columns, after being re-sized and/or re-located, the embodiments of the present invention should be considered not to be so limited. For instance, keyboard change module 144 could be configured to change the arrangement of the keys to better fit within the defined bounded area. Thus, for example, the key arrangement of a keypad could be changed to two rows by six columns, as well as other possible configurations.

As further depicted in FIGS. 4A and 4B, in one embodiment, not only is the drag path (e.g., L, J) used to define the bounded area, but keyboard change module 144 may also be configured to ensure that when the keypad is re-sized, at least portions or every key of the keypad are within the defined bounded area. For example, in FIGS. 4A and 4B, at least approximately half of the furthest reachable key is within the defined bounded area.

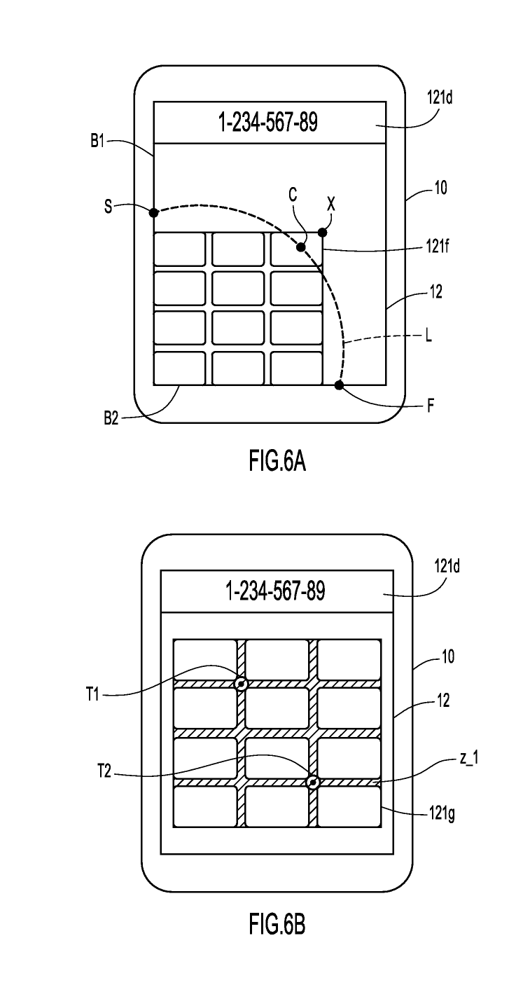

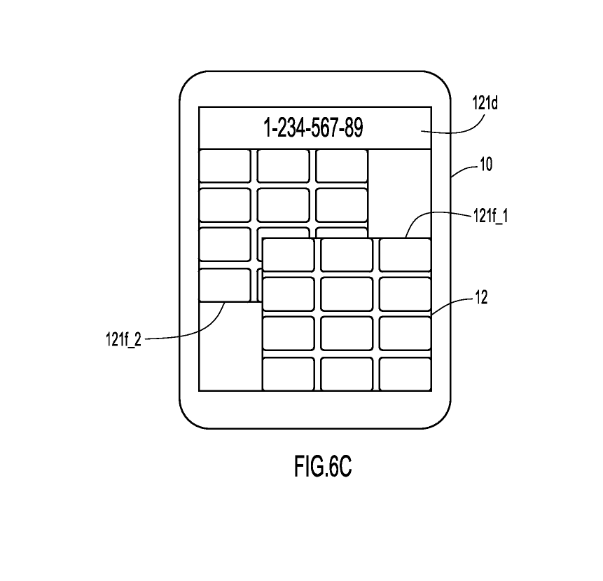

The foregoing embodiment encompasses, essentially, a real-time change to a keypad size and location according to a user's reach. However, in another possible embodiment, a user may pre-configure a customized size/location of a keypad (e.g., in a user settings function of the electronic device) and, when a keypad operation is executed by electronic device 10, a default size of the keypad is rendered along with additional or alternate keys (shown in FIG. 6B) that are configured, when selected, to cause electronic device 10 to display the smaller, customized version of the keypad.

Reference is now made to FIG. 5, which is a flow chart illustrating example processing steps performed by electronic device 10 in accordance with another embodiment of the present invention, and FIGS. 6A-6C depict how a keypad (keyboard) may be rendered or displayed on electronic device 10 in accordance with the processing steps of FIG. 5.

As shown in FIG. 5, process 500, begins at step S501 wherein a particular type of touch operation is detected on touch screen 12. Specifically, a start point S and an end point F of a first touch operation, as well as a moving or dragging operation associated with the start and end points are detected.

At step S502 it is determined whether the start and end points are on a boundary of touch screen 12. If not, process 500 returns to step S501. If the start point S and end point F are on one or more boundaries of touch screen 12, then process 500 continues with step S503. At this step, a bounded area is defined using the boundaries of touch screen 12 and a drag path (e.g., L in FIG. 6A). In this case, and as shown in FIG. 6A, a resized and re-located keypad may already be displayed on the display. By virtue of the touch operation beginning and ending on boundaries of touch screen 12, process 500 interprets such an operation to be intended to re-size and/or re-locate the keypad still further. As such, at step S503, a bounded area is then defined by the boundaries (e.g., B1, B2) and a drag path L between the start point S and the end point F. In this case, drag path L passes through key 122c of keypad 121f via a center point C. In accordance with the instant embodiment, a further reduction in size of the keypad can be based on a proportional move from corner X of key 122c translated to point C. That is, the entire keypad can be reduced in size proportional to a distance between point X and point C, such that an upper right-hand corner of the keypad, and in particular, the upper right hand corner of key 122c is arranged to be at point C. Those skilled in the art will appreciate that the keypad can likewise be increased in size. Such a re-sized, re-located keypad, or information sufficient to generate such a re-sized and/or relocated keypad, can be stored in memory 14 as a pre-configured/customized keypad.

At step S504 (and, e.g., after a pre-configured/customized re-sized/re-located keypad has been stored in memory 14) a user operates electronic device 10 to display the keypad, and a full or default size keyboard is displayed along with alternate touch keys rendered, e.g., in an area z_1 between adjacent keys. More specifically, alternate keys T1 and/or T2 (FIG. 6B) can be displayed when the full size or default size keypad is displayed.

At step S505 it is determined whether one of the alternate keys T1, T2 has been selected. If neither is selected then process 500 loops back to step S505. If one of the alternate keys is selected then process 500 continues with step S506 at which the previously stored re-sized/re-located keypad corresponding to the selected alternate key is selected. Finally, at step S507 the keypad so selected is displayed. FIG. 6C shows keypad 121f_1 displayed as a result of alternate key T2 being selected (e.g., a user using their right hand thumb) and keypad 121f_2 when alternate key T1 is selected (e.g., a user using their left hand thumb). Those skilled in the art will appreciate that multiple pre-configured customized keypads can be stored in memory.

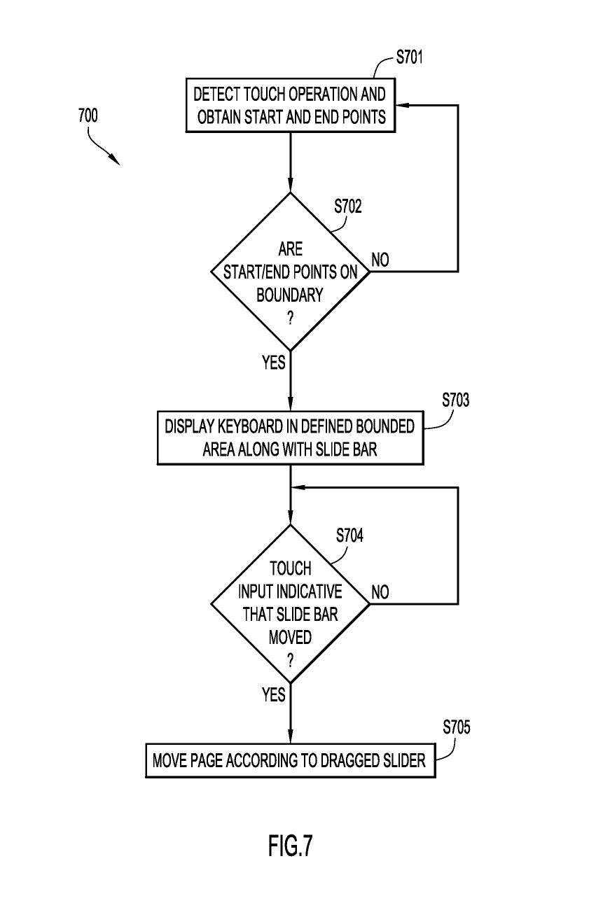

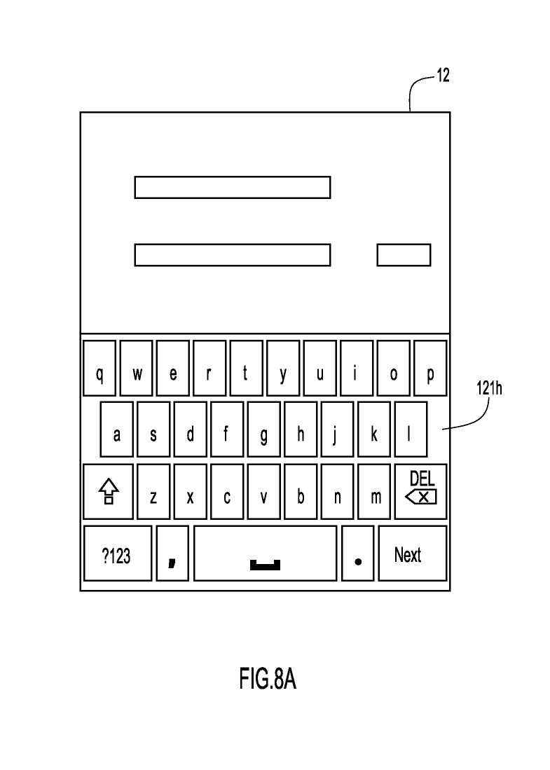

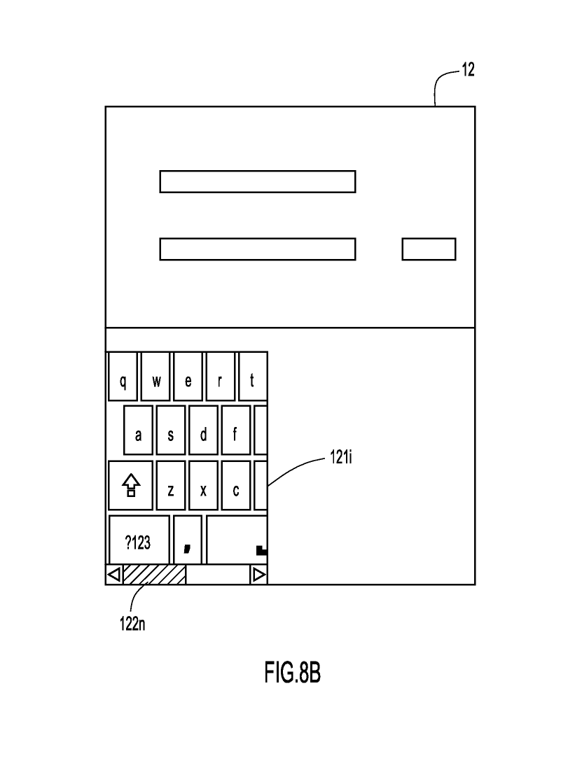

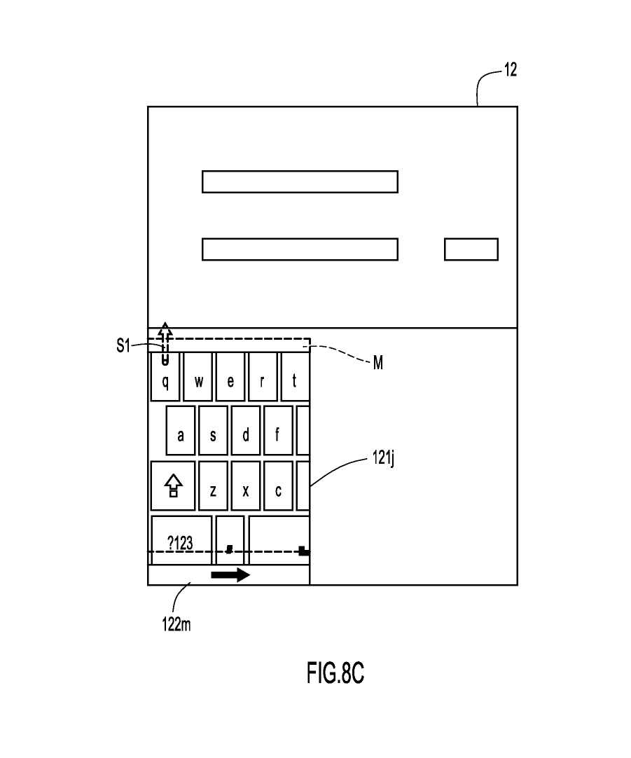

FIG. 7 is a flow chart illustrating example processing steps 700 performed by electronic device 10 in accordance with yet another embodiment of the present invention, and FIGS. 8A-8C depict how a keypad (keyboard) may be rendered or displayed on the electronic device in accordance with process 700. In this case, the keyboard is a full size QWERTY keyboard 121h, as shown in FIG. 8A.

Steps S701 and S702 are identical to steps S501 and S502 of FIG. 5 and a description thereof will not be repeated here. At step S703, a slide bar 122n and a paginated selection 121i of the entirety of keyboard 121h is displayed. In this configuration, a user may be able to reach all of the keys in the displayed page or portion of the keyboard 121i with a single hand. As can also be seen, the paginated selection 121i is slightly reduced in size compared to that same portion of keyboard 121h, in view of the reduced size corresponding to a bounded defined area.

At step S704 it is determined whether a touch input is indicative of slide bar 122n being moved. If no, then process 700 returns to step S704. If a touch input is indicative of slide bar 122n being moved in, e.g., the direction 122m, then at step S705 a different portion or page of keyboard 121h may be displayed corresponding to the magnitude or distance of the touch input. That is, through the manipulation of slide bar 122n, a user can gain access to other potions of keyboard 121h.

FIG. 8C shows still another operation. Specifically, a user can drag the displayed portion of keyboard 121j in the direction S1 to better meet the user's needs. That is, since the keyboard 121j is already rendered smaller than an area previously allotted to the keyboard, a user may drag the keyboard to a different position on touch screen 12, as indicated by M. This feature is also applicable to the dial keypad as well.

In summary, the electronic device and method in accordance with embodiments of the present invention enable improved single hand use of an electronic device. That is, a user can customize a touch range of a keypad or keyboard on the electronic device. The re-sized and/or re-located version may be stored in memory for later display upon user request. Moreover, not only can a given keypad or keyboard be reduced in size and re-located on a display, but selected portions of a keyboard may also be displayed along with a means to paginate through or access other selected portions, using a single hand.

The above description is intended by way of example only.

What is claimed is:

1. A method, comprising:
displaying a set of keys on an electronic device having a touch screen and a display;
detecting a touch operation input via the touch screen, the touch operation including a start point, an end point and a drag path between the start point and the end point; and
when the start point is located at a first boundary of the touch screen and the end point is located at a second boundary of the touch screen, defining a bounded area of the display according to the first boundary of the touch screen, the second boundary of the touch screen and the drag path in which the set of keys is to be re-displayed.

2. The method of claim 1, further comprising:
re-displaying the set of keys on the display such that at least a portion of each key in the set of keys is displayed within the bounded area.

3. The method of claim 2, wherein the set of keys comprises a keypad, and the method further comprises:
re-displaying the keypad such that the entirety of each key of the keypad is within the bounded area.

4. The method of claim 2, wherein the set of keys comprises a QWERTY keyboard, and the method further comprises:
re-displaying a selected portion of the keyboard along with a slide bar configured to gain access to other portions of the keyboard.

5. The method of claim 4, further comprising:
in response to detecting a touch operation indicative of a drag of the slide bar, displaying another portion, among the other portions, of the keyboard.

6. The method of claim 1, further comprising:
displaying a default size of the set of keys and an alternate key, the alternate key corresponding to a previously stored re-sized version of the set of keys; and
when the alternate key is selected, displaying the re-sized version of the set of keys.

7. The method of claim 6, further comprising:
displaying the alternate key within an area between adjacent keys of the default size of the set of keys.

8. The method of claim 1, further comprising:
detecting a touch operation indicative of a drag beginning within the bounded area, and dragging the set of keys in a same direction as the drag.

9. The method of claim 1, wherein the first boundary and the second boundary are different boundaries.

10. The method of claim 1, wherein the first boundary and the second boundary are the same boundary.

11. An electronic device, comprising:
a touch screen including an associated display;
a memory; and
a processor in communication with the touch screen and memory,
wherein the memory includes
a detection module configured to detect a touch operation input via the touch screen, the touch operation including a start point, an end point and a drag path between the start point and the end point;
a keyboard change module configured to define a bounded area of the display according to the first boundary of the touch screen, the second boundary of the touch screen and the drag path; and
a keyboard display module configured to cause a re-sized version of a set of keys to be displayed substantially in the bounded area of the display.

12. The electronic device of claim 11, wherein the keyboard display module is configured to cause the re-sized version of the set of keys to be displayed such that at least a portion of each key in the re-sized version of the set of keys is displayed within the bounded area.

13. The electronic device of claim 11, wherein the re-sized set of keys comprises a keypad.

14. The electronic device of claim 11, wherein the re-sized set of keys comprises a keyboard, and the keyboard display module is configured to display a selected portion of the keyboard along with a slide bar configured to gain access to other portions of the keyboard.

15. The electronic device of claim 14, wherein the keyboard display module is configured to display another portion, among the other portions, of the keyboard in response to a touch operation on the touch screen indicative of a drag of the slide bar.

16. The electronic device of claim 11, wherein the keyboard display module is further configured to display a default size of the set of keys and an alternate key, the alternate key corresponding to a previously stored re-sized version of the set of keys; and
in response to a selection of the alternate key, the keyboard display module is further configured to display the previously stored re-sized version of the set of keys.

17. The electronic device of claim 16, wherein the keyboard display module is configured to displaying the alternate key within an area between adjacent keys of the default size of the set of keys.

18. The electronic device of claim 11,
wherein when the detection module detects a touch operation indicative of a drag beginning within the bounded area, the keyboard display module is configured to move the re-sized version of the set of keys a same direction as the drag.

19. The electronic device of claim 11, wherein the first boundary and the second boundary are different boundaries.

20. The electronic device of claim 11, wherein the first boundary and the second boundary are the same boundary.
